(19) United States
(12) Patent Application Publication
(10) Pub. No.: US 2026/0266662 A1
(43) Pub. Date: Sep. 10, 2026

(54) PHOTODETECTION DEVICE

(71) Applicant: SONY SEMICONDUCTOR SOLUTIONS CORPORATION, KANAGAWA (JP)

(72) Inventor: Masatoshi IWAMOTO, KUMAMOTO (JP)

(21) Appl. No.: 18/873,693

(22) PCT Filed: May 2, 2023
(86) PCT No.: PCT/JP2023/017179

§ 371 Date: Dec. 10, 2024

(30) Foreign Application Priority Data
Jun. 15, 2022 (JP) 2022-096375

(51) Int. Cl. G01J 3/51

(52) U.S. Cl. CPC G01J 3/51

(57) ABSTRACT

The present invention is a photodetection device including a pixel array section. Each of the plurality of pixels of the pixel array section includes a photoelectric conversion element that generates an electric signal corresponding to received light, and a color filter (CF) formed on a light receiving surface of the photoelectric conversion element. The plurality of pixels includes a first pixel including a first CF that transmits light of a first wavelength band, a second pixel adjacent to the first pixel and including a second CF that transmits light of a second wavelength band, a third pixel adjacent to the first pixel and including a third CF that transmits light of a third wavelength band having a peak wavelength shorter than a peak wavelength of the second wavelength band, and a fourth pixel adjacent to the first pixel and including a fourth CF that transmits light of a fourth wavelength band having a peak wavelength shorter than a peak wavelength of the third wavelength band. The second pixel includes a first outer periphery CF that is formed so as to surround a periphery of the second CF and transmits light of the third wavelength band.

### TECHNICAL FIELD

The present technology relates to a photodetection device, and particularly relates to a photodetection device using color filters of a plurality of colors.

### BACKGROUND ART

A photodetection device in which photoelectric conversion elements are arranged in an array is widely used in an imaging device such as a camera, the photoelectric conversion element outputting an electric signal on the basis of charges accumulated according to incident light. A photodetection device corresponding to a color image includes a color filter on a light receiving surface of each photoelectric conversion element such that each photoelectric conversion element receives only light of any one color of red, green, and blue (RGB). A configuration including such a photoelectric conversion element in the photodetection device is referred to as a “light receiving pixel” or simply a “pixel”. In recent years, in order to improve high sensitivity and low illuminance performance, a photodetection device using a color filter further including white (W) in addition to RGB has been provided.

In the photodetection device using the color filter, in a case where light is obliquely incident on a light receiving surface, what is called color mixture (crosstalk) in which light transmitted through a color filter of an adjacent pixel enters in a certain pixel is likely to occur. In particular, in the photodetection device using the color filter having a four-color pixel array of RGBW, there is a problem in that pixels (W pixels) of a W color filter are easily affected by crosstalk, and the output characteristics of the W pixels easily vary.

Therefore, some techniques for suppressing variations in the output characteristics (sensitivity characteristics) of pixels have been proposed.

For example, Patent Document 1 below discloses an imaging device including a plurality of pixels including a color filter that disperses incident light and transmits incident light of a predetermined wavelength, and a photoelectric conversion section that receives the incident light transmitted through the color filter and generates signal charges. The imaging device of Patent Literature 1 includes a first pixel including a color filter having first spectral characteristics, four second pixels including a color filter having spectral characteristics similar to the first spectral characteristics and adjacent to the first pixel, and a partition wall disposed between the respective color filters of the first pixel and the second pixel and having spectral characteristics different from the first spectral characteristics and the second spectral characteristics.

Furthermore, Patent Document 2 below discloses a solid-state imaging element including a W pixel that is a specific pixel, at least one type of pixel among an R pixel, a G pixel, and a B pixel, and a light shielding film for physically shielding light between pixels, in which the light shielding line width is extended between the W pixel and adjacent pixels adjacent to the W pixel among the pixels.

### CITATION LIST

### Patent Document

Patent Document 1: Japanese Patent Application Laid-Open No. 2020-150267

Patent Document 2: Japanese Patent Application Laid-Open No. 2016-096234

### SUMMARY OF THE INVENTION

### Problems to be Solved by the Invention

However, in a case where there is a plurality of arrangement cycles of pixels of other colors adjacent to the W pixel, there is a problem in that the output itself of the W pixel is shifted according to the number of arrangement cycles, and an output step is generated. The imaging device disclosed in Patent Document 1 described above can suppress variations in output characteristics with respect to a specific pixel array, but has a problem in that it is not possible to completely suppress variations with respect to a color pixel array in which a step may occur in the output of the W pixel.

Furthermore, the solid-state imaging element disclosed in Patent Document 2 can suppress variations in the output of the W pixels by forming the light shielding film to have a large line width, but has a problem in that the output of the W pixels themselves may decrease.

Therefore, the present disclosure proposes a technology capable of suppressing variations in output characteristics of pixels due to crosstalk between pixels in a photodetection device using a color filter.

More specifically, the present disclosure proposes a technology capable of suppressing crosstalk from an adjacent pixel to a W pixel in a photodetection device using a color filter of a four-color pixel array, thereby effectively suppressing variations in output characteristics and output steps between the W pixels.

### Solutions to Problems

The present technology for solving the above-described problems includes the following matters specifying the invention or technical features.

The present technology according to a certain aspect is a photodetection device including a pixel array section in which a plurality of pixels is arranged in an array. Each of the plurality of pixels includes a photoelectric conversion element capable of generating an electric signal corresponding to received light, and a color filter that is formed according to a predetermined color filter pattern on a light receiving surface of the photoelectric conversion element and transmits light of a specific wavelength band among the light, the light receiving surface receiving the light. Furthermore, the plurality of pixels includes a first pixel including a first color filter that transmits light of a first wavelength band (for example, white light), a second pixel adjacent to the first pixel and including a second color filter that transmits light of a second wavelength band (for example, red light), a third pixel adjacent to the first pixel and including a third color filter that transmits light of a third wavelength band (for example, green light) having a peak wavelength shorter than a peak wavelength of the second wavelength band, and a fourth pixel adjacent to the first pixel and including a fourth color filter that transmits light of a fourth wavelength band (for example, blue light) having a peak wavelength shorter than a peak wavelength of the third wavelength band. Then, the second pixel includes a first outer peripheral color filter that is formed so as to surround the second color filter and transmits light of the third wavelength band.

Furthermore, the present technology according to another aspect is a photodetection device in which the fourth pixel in the plurality of pixels includes a third outer peripheral color filter that is formed so as to surround the second color filter and transmits light of the second wavelength band.

Moreover, the present technology according to another aspect is a photodetection device in which the second pixel in the plurality of pixels includes a fourth outer peripheral color filter that is formed so as to surround the second color filter and transmits light of the second wavelength band.

Note that, in the present specification and the like, a means does not simply mean a physical means, and includes a case where a function of the means is implemented by software. Furthermore, a function of one means may be implemented by two or more physical means, or functions of two or more means may be implemented by one physical means. Furthermore, a “system” refers to a logical assembly of a plurality of devices (or functional modules that implement specific functions), and it does not matter whether or not each device or each functional module is in a single housing.

Other technical features, objects, effects, or advantages of the present invention will be clarified by the following embodiments described with reference to the accompanying drawings. The effects described herein are only examples, and the effects of the present specification are not limited to these effects. Additional effects may also be obtained.

### BRIEF DESCRIPTION OF DRAWINGS

FIG. 1 is an exploded perspective view for explaining an example of a schematic structure of a photodetection device according to a first embodiment of the present technology.

FIG. 2 is a partial cross-sectional view illustrating a schematic structure of a pixel in a photodetection device according to an embodiment of the present technology.

FIG. 3 is a diagram illustrating an example of an RGBW pixel array in a general photodetection device.

FIG. 4 is an enlarged view illustrating a part of the RGBW pixel array illustrated in FIG. 3.

FIG. 5 is a diagram showing quantum efficiency (Qe) of each W pixel in the RGBW pixel array of the general photodetection device.

FIG. 6 is a partial plan view for explaining an example of a color arrangement configuration of outer peripheral color filters in the RGBW pixel array in the photodetection device according to the embodiment of the present technology.

FIG. 7 is a partial cross-sectional view for explaining a schematic structure of a pixel in a VII-VII′ cross section in the RGBW pixel array illustrated in FIG. 6.

FIG. 8 is a partial plan view for explaining another example of a color arrangement configuration of outer peripheral color filters in the RGBW pixel array in the photodetection device according to the embodiment of the present technology.

FIG. 9 is a partial plan view for explaining still another example of a color arrangement configuration of outer peripheral color filters in the RGBW pixel array in the photodetection device according to the embodiment of the present technology.

FIG. 10 is a partial plan view for explaining still another example of a color arrangement configuration of outer peripheral color filters in the RGBW pixel array in the photodetection device according to the embodiment of the present technology.

FIG. 11 is a view for explaining an example of a method of forming a color filter in a manufacturing process of the photodetection device according to the embodiment of the present technology.

FIG. 12 is a partial cross-sectional view illustrating a schematic structure of a pixel in a photodetection device according to the embodiment of the present technology.

FIG. 13 is a partial plan view for explaining a pixel shielding film in the RGBW pixel array illustrated in FIG. 12.

FIG. 14 is a partial plan view for explaining an example of a color arrangement configuration of outer peripheral color filters in the RGBW pixel array in the photodetection device according to the embodiment of the present technology.

FIG. 15 is a partial plan view for explaining another example of a color arrangement configuration of outer peripheral color filters in the RGBW pixel array in the photodetection device according to the embodiment of the present technology.

FIG. 16 is a partial plan view for explaining still another example of a color arrangement configuration of outer peripheral color filters in the RGBW pixel array in the photodetection device according to the embodiment of the present technology.

FIG. 17 is a block diagram illustrating an example of a schematic configuration of a vehicle control system.

FIG. 18 is an explanatory view illustrating an example of an installation position of an outside-vehicle information detection section and an imaging section.

### MODE FOR CARRYING OUT THE INVENTION

Hereinafter, embodiments of the present technology will be described with reference to the drawings. However, the embodiments described below are merely examples, and are not intended to exclude applications of various modifications and techniques that are not explicitly described below. The present technology can be implemented by various modifications (for example, combination of each embodiment, or the like) within the scope thereof. Furthermore, in the following description of the drawings, the same or similar parts are denoted by the same or similar reference signs. The drawings are merely schematic representations, and dimensions and ratios of the dimensions therein or the like do not necessarily match the actual ones.

Parts having different dimensional relations or ratios different between the drawings may be included.

In this section, the following items will be described.
1. First Embodiment
2. Second Embodiment
3. Third Embodiment
4. Example of Application to Mobile Object
5. Conclusion

### First Embodiment

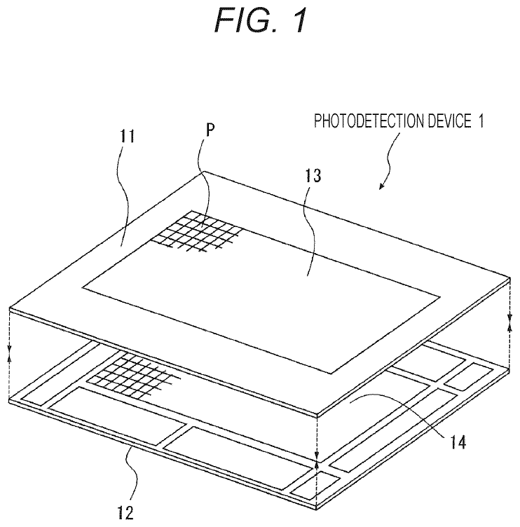

FIG. 1 is an exploded perspective view for explaining an example of a schematic structure of a photodetection device according to an embodiment of the present technology. As illustrated in the drawing, a photodetection device 1 is an LSI chip in which a first semiconductor substrate 11 and a second semiconductor substrate 12 are stacked. The first semiconductor substrate 11 and the second semiconductor substrate 12 are bonded by, for example, flip-chip mounting. As described later, the photodetection device 1 can be applied to various products, and can function as an imaging section that captures an image.

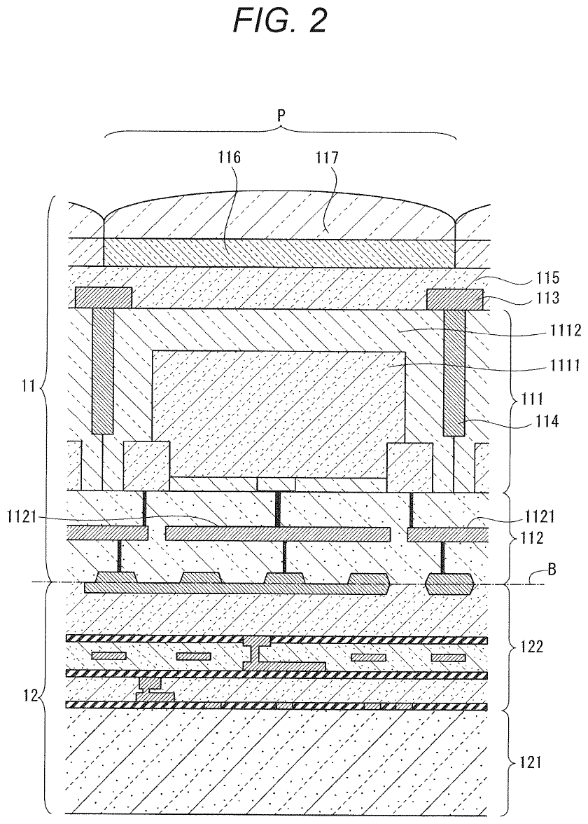

The first semiconductor substrate 11 is, for example, a substrate on which a pixel array section 13 in which a plurality of light receiving elements constituting a pixel P is arranged in an array is formed. Each light receiving element is a semiconductor element including a photoelectric conversion element such as a photodiode. A color filter 116 and an on-chip lens 117 are stacked and formed on the photoelectric conversion element to form a pixel P (see FIG. 2). Light incident on each pixel P is condensed by the on-chip lens 117, and the light of the wavelength band other than a specific wavelength band is cut by the color filter 116 and reaches the photoelectric conversion element. The photoelectric conversion element generates a charge according to the intensity of light received through the color filter 116, and outputs an electric signal based on the generated charge. In the present disclosure, four types of color filters obtained by adding white (W) to the three primary colors (red (R), green (G) and blue (B) ) of light are used for the color filters 116, and are arranged and formed according to a predetermined color filter pattern.

The second semiconductor substrate 12 is a substrate on which various semiconductor integrated circuits 14 are formed. The semiconductor integrated circuit 14 includes, for example, a PLL circuit that generates a clock, a pixel control circuit that controls the operation of each pixel P, a drive circuit that drives a specific pixel P to read an electric signal under the control of the pixel control circuit, a signal processing circuit that processes the read electric signal, an interface circuit for enabling connection to the outside, and the like. These circuits can be integrally configured as a system on a chip (SoC) such as a CMOS LSI, for example.

Note that, in the present disclosure, the photodetection device 1 has a two-layer stacked structure in which the first semiconductor substrate 11 and the second semiconductor substrate 12 are bonded, but is not limited thereto, and may have a three-layer or more stacked structure. Alternatively, the photodetection device 1 may have a structure in which the pixel array section 13 and the semiconductor integrated circuit 14 are juxtaposed on a single substrate.

FIG. 2 is a partial cross-sectional view illustrating a schematic structure of the pixel P in the photodetection device 1 according to the embodiment of the present technology. That is, FIG. 2 illustrates a part of a cross-sectional structure of a main part of a semiconductor substrate (LSI chip) in which the first semiconductor substrate 11 and the second semiconductor substrate 12 are bonded. In the drawing, an alternate long and short dash line denoted by reference numeral B indicates a bonding surface between the first semiconductor substrate 11 and the second semiconductor substrate 12. Note that, in the present disclosure, the photodetection device 1 is a back-illuminated CMOS image sensor, but is not limited thereto, and may be, for example, a front-illuminated CMOS image sensor.

As illustrated in the drawing, the first semiconductor substrate 11 includes a silicon single crystal Si semiconductor layer 111 and a wiring layer 112 stacked on the front surface (the lower surface in the drawing) of the Si semiconductor layer 111.

The Si semiconductor layer 111 includes a semiconductor region 1111 constituting a light receiving element. The semiconductor region 1111 is a region in which various semiconductor elements such as photodiodes and transistors are formed, and is covered with, for example, a silicon-oxide film 1112.

The wiring layer 112 includes various wiring patterns 1121. The semiconductor element in the semiconductor region 1111 is electrically connected to the wiring pattern 1121 via a via. Typically, the wiring layer 112 can be configured by stacking a plurality of wiring layers with an interlayer insulating film interposed therebetween. The wiring pattern 1121 includes a metal material such as aluminum (Al) or copper (Cu), for example, but is not limited thereto.

A light shielding film 113 is formed on the back surface (the upper surface in the drawing) of the Si semiconductor layer 111. That is, the light shielding film 113 is formed with a predetermined width along the periphery of the semiconductor region 1111 and defines the opening (light receiving region) of the light receiving element. The light shielding film 113 includes, for example, tungsten. The light shielding film 113 suppresses entry of light from the adjacent pixels P, thereby contributing to reduction of crosstalk (color mixture). As described in other embodiments, the width of the light shielding film 113 is appropriately defined in accordance with the wavelength characteristics of the color filter 116 in order to more effectively reduce color mixture. Note that the Si semiconductor layer 111 may be provided with a pixel separation portion 114 formed in a trench shape along the periphery of the semiconductor region 1111. The pixel separation portion 114 also effectively reduces the occurrence of crosstalk in the Si semiconductor layer 111.

Furthermore, on the back surface of the Si semiconductor layer 111, the color filter 116 is formed via a planarization film 115, for example, and the on-chip lens 117 is further formed on the color filter 116. The color filter 116 includes, for example, an organic material to which a predetermined color material (any one of RGBW) is added for each pixel P, and is formed by using, for example, a photolithography/etching technique. Hereinafter, in a case where the pixels P in which the color filters 116 that transmit light of any one of the wavelength bands of RGBW are formed are distinguished for each color, each pixel P is described as “an R pixel” or “a pixel P (R)”, for example. Note that, since the W pixel is the pixel P that receives light of all wavelength bands among visible light, a color filter 116W of the W pixel can include, for example, the transparent material of the on-chip lens 117. That is, a part of the on-chip lens 117 directly formed on the planarization film 115 is regarded as the color filter 116W. The W pixel, the R pixel, the G pixel, and the B pixel correspond to a first pixel, a second pixel, a third pixel, and a fourth pixel in the claims, respectively.

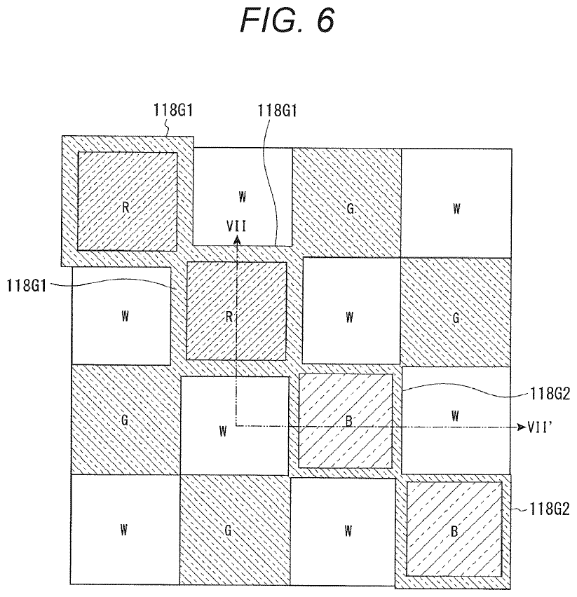

Furthermore, in the present disclosure, for each pixel P of RGB, in order to suppress a difference in output level between the W pixels, an outer peripheral color filter 118 that transmits other colors is formed so as to surround the periphery of the color filter 116 (see FIG. 6 and the like). As an example, a green outer peripheral color filter 118G can be formed around a color filter 116R of the R pixel and a color filter 116B of the B pixel. As another example, a red outer peripheral color filter 118R can be formed around the color filter 116B of the B pixel. As still another example, a blue outer peripheral color filter 118R can be formed around the color filter 116R of the R pixel.

The on-chip lens 117 is an optical lens configured to effectively condense light or form an image of light incident from the outside on the pixel P (that is, the photoelectric conversion element of the semiconductor region 1111). For example, the on-chip lens 117 is formed such that incident light is coupled for each pixel P. Alternatively, the on-chip lens 117 may be shared by a plurality of adjacent pixels P constituting a pixel block. In other words, one on-chip lens 117 may be provided for each pixel block. The pixel block corresponds to a pixel unit indicating the resolution of the image to be reproduced.

The second semiconductor substrate 12 includes a Si semiconductor layer 121 and a wiring layer 122 stacked on the Si semiconductor layer 121. In the Si semiconductor layer 121, for example, the above-described various semiconductor integrated circuits 14 are formed. The wiring layer 122 can also typically include a plurality of wiring layers stacked together with an interlayer insulating film interposed therebetween.

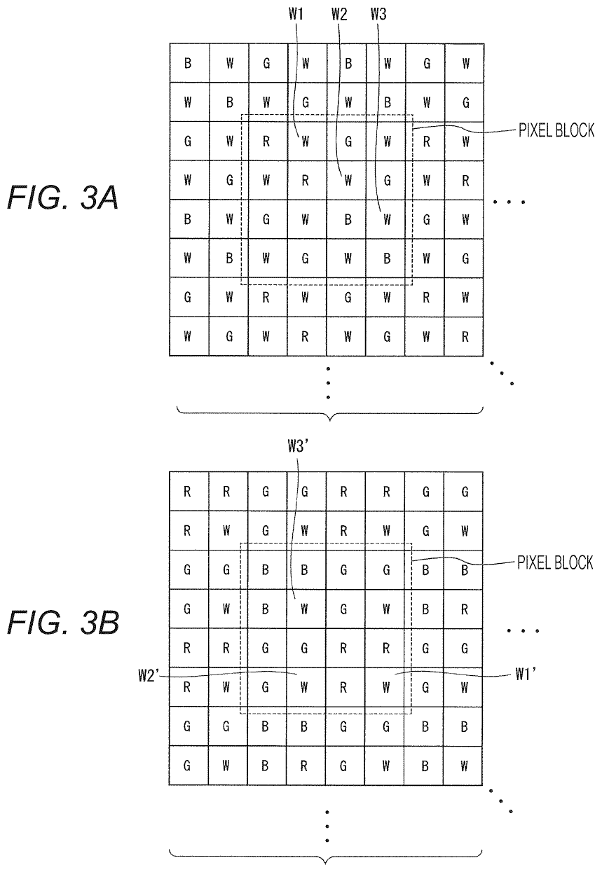

Here, a typical RGBW pixel array (color filter pattern) in the photodetection device 1 will be described. FIG. 3 is a diagram illustrating an example of an RGBW pixel array in a general photodetection device. More specifically, FIG. 3(a) illustrates an example of an RGBW pixel array in which W pixels are arranged on the basis of a Bayer array, and FIG. 3(b) illustrates an example of an RGBW pixel array in which W pixels are arranged on the basis of a quad Bayer array. Note that, in the drawing, the outer peripheral color filter 118 is not illustrated for convenience.

As illustrated in these drawings, in the photodetection device 1, the RGBW pixel array in which RGB pixels are arranged around W pixels is configured so as to output an electrical signal capable of faithfully reproducing an image of received light.

In such an RGBW pixel array, there are three array patterns of pixels of colors other than W adjacent to the periphery of the W pixels. That is, in the RGBW pixel array as illustrated in FIG. 3(a), the array pattern includes a first array pattern in which the pixel P adjacent to the pixel P (W1) (first W pixel) is two G pixels and two R pixels, a second array pattern in which the pixel P adjacent to the pixel P (W2) (second W pixel) is two G pixels, one R pixel, and one B pixel, and a third array pattern in which the pixel P adjacent to the pixel P (W3) (third W pixel) is two G pixels and two B pixels.

Furthermore, in the RGBW pixel array as illustrated in FIG. 3(b), the array pattern includes a first array pattern in which the pixel P adjacent to the pixel P (W1′) (first W pixel) is two G pixels and two R pixels, a second array pattern in which the pixel adjacent to the pixel P (W2′) (second W pixel) is two G pixels, one R pixel, and one B pixel, and a third array pattern in which the pixel adjacent to the pixel P (W3′) (third W pixel) is two G pixels and two B pixels.

Then, in such an RGBW pixel array, the amount of light entering from a pixel adjacent to the W pixel with respect to the amount of light directly incident on the W pixel is different for each of the three array patterns, and a step is generated in the output level itself of the electric signal extracted from the W pixel.

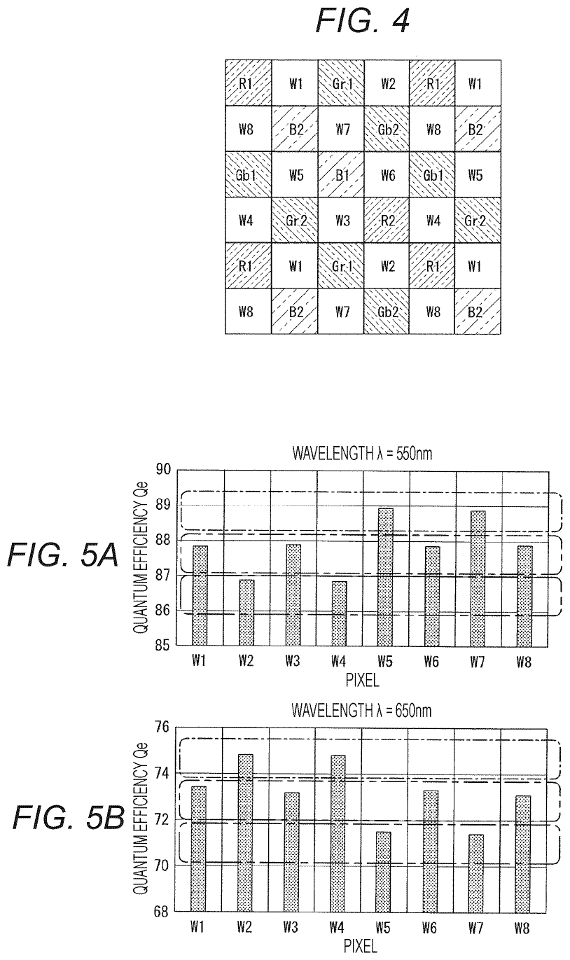

For example, an output level (quantum efficiency Qe) of an electrical signal extracted from each W pixel is considered in a case where the pixel P of the photodetection device having the RGBW pixel array as illustrated in FIG. 3(a) is irradiated with light having a wavelength λ=550 nm and in a case where the pixel P is irradiated with light having a wavelength λ=650 nm. Now, focusing on the pixels P in the 6×6 region as illustrated in FIG. 4 in the RGBW pixel array illustrated in FIG. 3 (a), there are eight W pixels P (W1) to P (W8) in the 6×6 region (in the drawing, simply referred to as “W1”, “W2”, and the like).

Furthermore, FIG. 5 is a graph showing the quantum efficiency Qe of each of the pixels P (W1) to P (W8).

As illustrated in FIG. 5(a), by irradiation with light having a wavelength λ=550 nm, the quantum efficiency Qe of the W pixels P (W5) and P (W7) having a high ratio of adjacent G pixels and B pixels is about 88.9%, which is the highest, and the quantum efficiency Qe of the W pixels P (W2) and P (W4) having a high ratio of adjacent R pixels and G pixels is about 86.8%, which is the lowest. Furthermore, the quantum efficiency Qe of the W pixels P (W1), P (W3), P (W6), and P (W8) is about 87.8%, which is a value therebetween.

On the other hand, as illustrated in FIG. 5(b), by irradiation with light having a wavelength λ=650 nm, the quantum efficiency Qe of the W pixels P (W2) and P (W4) having a high ratio of adjacent R pixels and G pixels is about 74.4%, which is the highest, and the quantum efficiency Qe of the W pixels P (W5) and P (W7) having a high ratio of adjacent G pixels and B pixels is about 70.8%, which is the lowest. Furthermore, the quantum efficiency Qe of the W pixels P (W1), P (W3), P (W6), and P (W8) is about 72.7%, which is a value therebetween.

As described above, it can be seen that the output level of each W pixel shows different values under the influence of the wavelength of the incident light and the color of the adjacent pixel P. Such a difference in the output level (output step) between the W pixels appears as a periodic luminance step in the reproduced image, and affects the image quality. Therefore, as described below, the photodetection device 1 of the present disclosure is configured to eliminate such an output step between the W pixels in the RGBW four-color pixel array using the outer peripheral color filter 118.

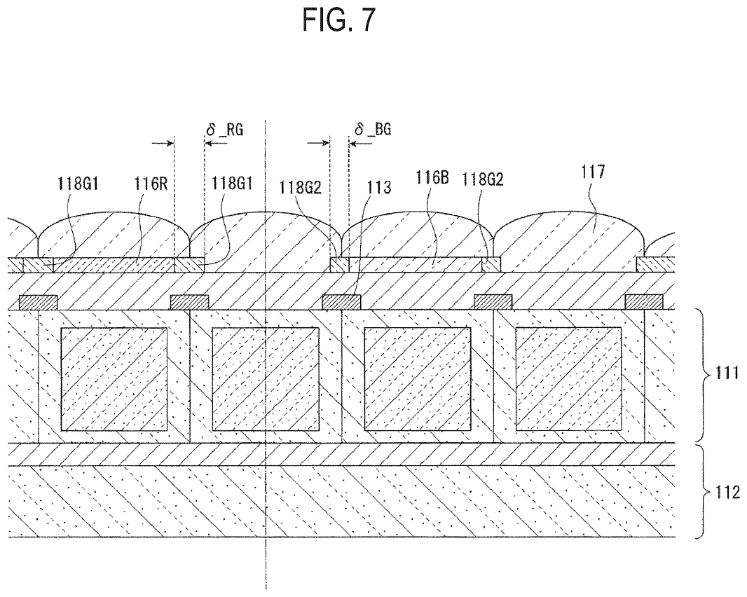

FIG. 6 is a partial plan view for explaining an example of a color arrangement configuration of outer peripheral color filters in the RGBW pixel array in the photodetection device 1 according to the embodiment of the present technology. Furthermore, FIG. 7 is a partial cross-sectional view for explaining a schematic structure of the pixel P in a VII-VII′ cross section in the RGBW pixel array illustrated in FIG. 6. Note that FIG. 7 illustrates a schematic structure of the pixel P illustrated in FIG. 2 in a further simplified manner for easy understanding.

As illustrated in these drawings, green outer peripheral color filters 118G1 and 118G2 are formed around the color filter 116R of the R pixel and the color filter 116B of the B pixel.

Therefore, the arrangement cycle of the color filters around each W pixel is unified in green. The outer peripheral color filters 118G1 and 118G2 may be continuous with a color filter 116G of the adjacent G pixel.

Furthermore, in the present example, the width of the outer peripheral color filter 118G1 around the R pixel is formed so as to be wider than the width of the outer peripheral color filter 118G2 around the B pixel (see FIG. 7). That is, the width of the outer peripheral color filter 118 is formed to be wider as the pixel P receives light having a longer wavelength. This is because, due to chromatic aberration, light having a longer wavelength has a property of being less likely to be condensed, and thus, deterioration in sensitivity is suppressed while suppressing color mixture between adjacent pixels P. Therefore, as in the present example, by forming the width of the outer peripheral color filter 118G1 around the R pixel to be wider than the width of the outer peripheral color filter 118G2 around the B pixel, it is possible to suppress deterioration in the sensitivity of the B pixel while further suppressing color mixture from the R pixel to the W pixel. The outer peripheral color filters 118G1 and G2 correspond to a first outer peripheral color filter and a second outer peripheral color filter in the claims.

As described above, the output step between the first W pixel (that is, a W pixel surrounded by G pixels×2 and R pixels×2) and the second W pixel (that is, a W pixel surrounded by G pixels×2, R pixels×1, and B pixels×1) and the output step between the second W pixel and the third W pixel (that is, a W pixel surrounded by G pixels×2 and B pixels×2) in the RGBW pixel array can be suppressed.

### Modifications

In the example described above, the color arrangement configuration of the color filter has been described in which the green outer peripheral color filter 118G is formed around the R pixel and the B pixel. However, the present invention is not limited thereto, and various color arrangement configurations of the outer peripheral color filter 118 can be adopted in relation to the color of the pixel P in order to suppress the output step of the W pixel.

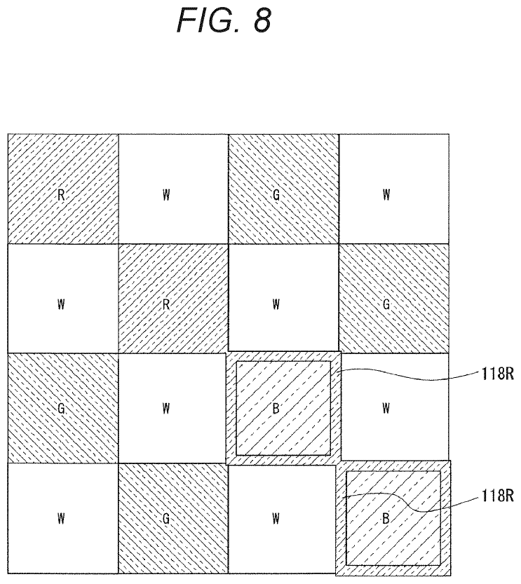

FIG. 8 is a partial plan view for explaining another example of a color arrangement configuration of outer peripheral color filters in the RGBW pixel array in the photodetection device 1 according to the embodiment of the present technology. As illustrated in the drawing, the color arrangement configuration of the outer peripheral color filter 118 of the present example is configured by forming the red outer peripheral color filter 118R around the B pixel. Therefore, the arrangement cycle of the color filters 116 around the W pixels is unified in green×2 and red×2. As a result, the output step between the W pixels can be eliminated. Note that the outer peripheral color filter 118R corresponds to a third outer peripheral color filter in the claims.

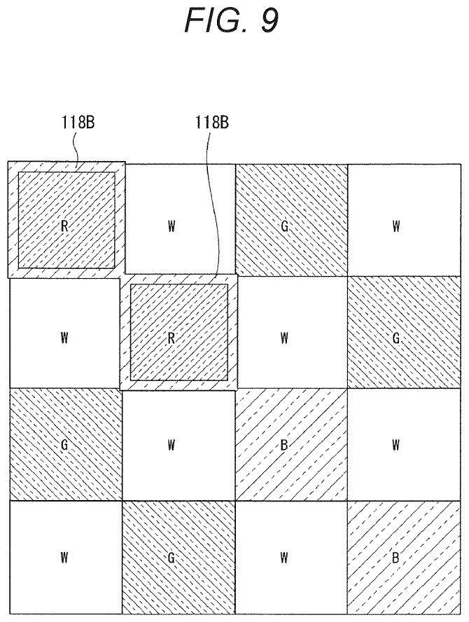

FIG. 9 is a partial plan view for explaining still another example of a color arrangement configuration of outer peripheral color filters in the RGBW pixel array in the photodetection device 1 according to the embodiment of the present technology. As illustrated in the drawing, in the outer peripheral color filter 118 of the present example, a blue outer peripheral color filter 118B is formed around the R pixel. Therefore, the arrangement cycle of the color filters 116 around the W pixels is unified in green×2 and blue×2. As a result, the output step between the W pixels can be eliminated. Note that the outer peripheral color filter 118B corresponds to a fourth outer peripheral color filter in the claims.

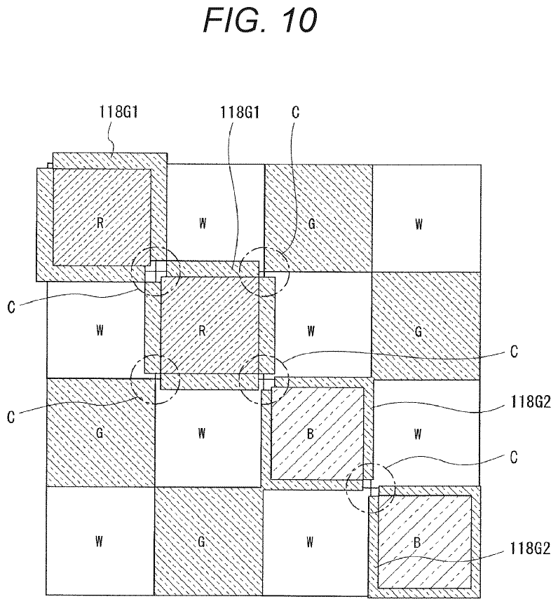

FIG. 10 is a partial plan view for explaining still another example of a color arrangement configuration of outer peripheral color filters in the RGBW pixel array in the photodetection device 1 according to the embodiment of the present technology.

The outer peripheral color filter 118 illustrated in the drawing is different from that illustrated in FIG. 6 in that the outer peripheral color filter 118 is not formed in the portion C where the pixels P intersect each other at the corner. That is, the outer peripheral color filter 118 surrounding the pixel P is not necessarily continuously formed, and may be partially missing (discontinuous).

A portion where the pixels P intersect each other at the corner is likely to be formed in a round shape in the forming process of the outer peripheral color filter 118, and there is a possibility that the effective region area of the surrounding pixels P (that is, W pixels) is reduced accordingly. Therefore, as in the present example, the outer peripheral color filter 118 is formed so as to avoid the intersection C of the corners of the pixels P, thereby securing the effective region area of the W pixels. As a result, it is possible to suppress deterioration in sensitivity of the W pixels while suppressing the occurrence of an output step between the W pixels.

Note that, since the width of the outer peripheral color filter 118G2 is narrower than that of the outer peripheral color filter 118G1, the influence on the effective region area of the W pixel is small. Therefore, the outer peripheral color filter 118G1 may not be formed only at the intersection of the corners of the R pixels.

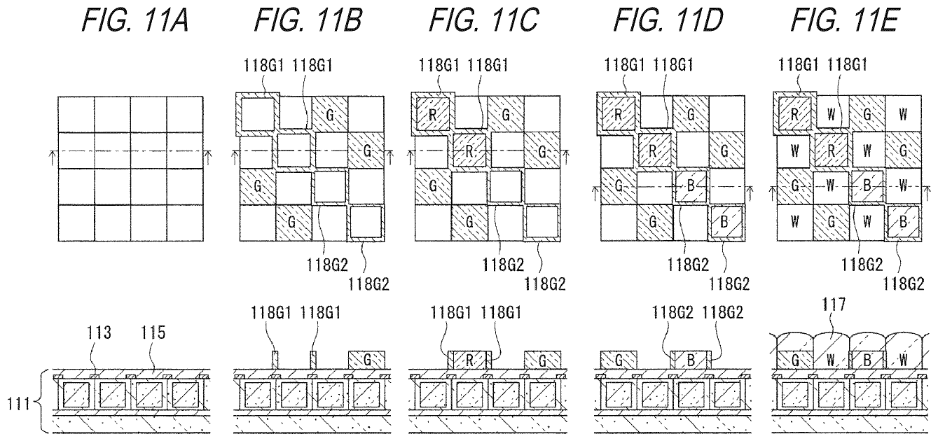

Next, a method of forming the color filter 116 in the manufacturing process of the photodetection device 1 will be described. FIG. 11 is a view for explaining an example of a method of forming a color filter in a manufacturing process of the photodetection device according to the embodiment of the present technology. In FIG. 11(a) to 11(e), the upper view is a schematic plan view of the photodetection device 1 in the manufacturing process, and the lower view is a schematic partial cross-sectional view of the corresponding cross section.

First, the back surface of the deposited Si semiconductor layer 111 is ground, and then the planarization film 115 is formed (FIG. 11(a)). Note that, although not illustrated, the light shielding film 113 is formed on the back surface of the Si semiconductor layer 111.

After the planarization film 115 is formed, the RGB color filters 116 are each formed. In the present example, it is assumed that the color filters 116 are formed in the order of GRB. Note that the W pixel is formed by using the material of the on-chip lens 117, for example.

That is, a green color filter material is formed on the planarization film 115, and is further exposed through a photomask pattern, and then etched. As a result, the green color filter 116G is formed, and the outer peripheral color filter 116G1 around the R pixel and the outer peripheral color filter 116G2 around the B pixel are simultaneously formed (FIG. 11(b)).

Subsequently, a red color filter material is formed on the planarization film 115, and is further exposed via a photomask pattern, and then etched, thereby forming the red color filter 116R (FIG. 11(c)).

Subsequently, a red color filter material is formed on the planarization film 115, and is further exposed via a photomask pattern, and then etched, thereby forming the red color filter 116B (FIG. 11(d), however, in FIG. 11(d), in order to describe the G pixel, the cross section is shifted by one pixel).

After the color filter 116 is formed using the RGB color filter material, the transparent material of the on-chip lens 117 is formed thereon. The amount of the transparent material is adjusted so that the portion corresponding to the W pixel is favorably filled. Subsequently, the transparent material is reflowed to form a lens curved surface, thereby forming the on-chip lenses 117 in an array (FIG. 11(e)).

As described above, the outer peripheral color filter 118 can be simultaneously formed by the follower mask pattern when the color filter 116 for the same color is formed. Therefore, since an additional manufacturing process and equipment for forming the outer peripheral color filter 118 are not required, it is possible to eliminate the above-described output step between the W pixels while avoiding an increase in manufacturing cost.

As described above, according to the present embodiment, by forming the outer peripheral color filter 118, entry of light of a specific wavelength band from the pixel P adjacent to the W pixel to the W pixel is effectively suppressed or adjusted, so that the output step between the W pixels can be eliminated or ignored. Therefore, good image quality can be obtained without appearing as a periodic luminance step in a reproduced image.

In particular, since the width of the outer peripheral color filter 118 is set according to the color of the color filter 116 of the pixel P, entry of light of a specific wavelength band from the adjacent pixel P to the W pixel can be more effectively suppressed or adjusted.

### Second Embodiment

The present embodiment is a modification of the first embodiment, and is characterized in that the width of the light shielding film 113 formed on the Si semiconductor layer 111 is defined in accordance with the wavelength characteristics of each of the RGB color filters 116.

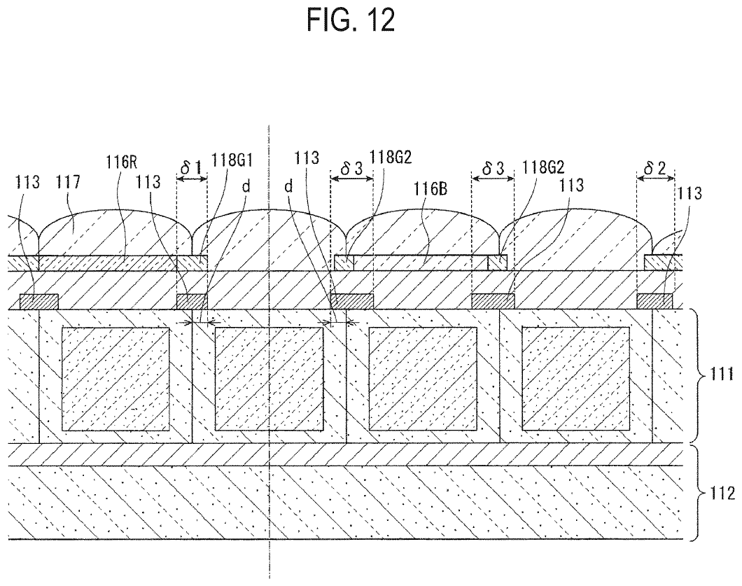

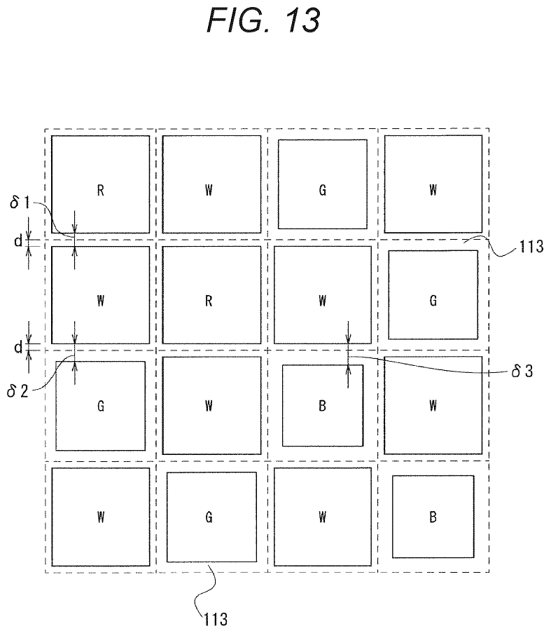

FIG. 12 is a partial cross-sectional view illustrating a schematic structure of a pixel in a photodetection device according to the embodiment of the present technology. Furthermore, FIG. 13 is a partial plan view for explaining a pixel shielding film in the RGBW pixel array illustrated in FIG. 12. A photodetection device 1 according to the present embodiment is different from the photodetection device 1 according to the first embodiment in that the width of a light shielding film 113 that defines the opening (light receiving region) of a light receiving element differs according to the wavelength of light transmitted through the color filter 116. Note that, in the following description, the color arrangement configuration of the outer peripheral color filters 118 in the RGBW pixel array illustrated in FIG. 6 will be described as an example, but the present invention is not limited thereto, and other color arrangement configurations may be used.

That is, since a part of the light passing through the color filter 116 is blocked by the light shielding film 113, light diffraction occurs. Since the diffracted light goes around to the adjacent semiconductor region 1111, color mixture occurs and image quality is deteriorated. At this time, since the diffraction angle increases as the wavelength of light increases, the influence of diffraction increases particularly in the R pixel through which light having a red wavelength passes.

Therefore, in the present embodiment, as illustrated in FIGS. 12 and 13, the light shielding film 113 surrounding each pixel P of RGB is formed such that the width of the light shielding film 113 surrounding the R pixel is the narrowest first width 81, the width of the light shielding film 113 surrounding the G pixel is the second width 52 thicker than the first width 81, and the width of the light shielding film 113 surrounding the B pixel is the third width 53 thicker than the second width 82 (that is, δ1<δ2<δ3). That is, as the width of the light shielding film 113 surrounding the pixel P becomes narrower, the size of the opening defined thereby becomes wider, so that the influence of diffraction can be reduced.

Furthermore, the width portion of the light shielding film 113 defining the opening of the W pixel may be bilaterally symmetrical about the boundary of the pixel P. That is, the width d of the portion extending inward to define the opening of the W pixel from the boundary line between the W pixel and the pixel P adjacent thereto is the same.

As described above, according to the present embodiment, it is possible to further suppress the influence of color mixture due to the asymmetry of each pixel P adjacent to the W pixel while suppressing the influence of diffraction for each wavelength.

### Third Embodiment

The present embodiment is a modification of the first or second embodiment, and is characterized in that the outer peripheral color filter 118 is applied to the RGBW pixel array in which the W pixels are arranged on the basis of the quad Bayer array.

In the RGBW pixel array in which the W pixels are arranged on the basis of the quad Bayer array, a block pixel is configured by arranging a set of four pixels P in the Bayer array (see FIG. 3(b)), and one W pixel is included in each set of the four pixels P. Even in such an RGBW pixel array, the amount of light entering from the pixel P adjacent to the W pixel with respect to the amount of light directly incident on the W pixel is different for each of the three array patterns, and a step is generated in the output level itself of the electric signal extracted from the W pixel. Therefore, by forming the outer peripheral color filter 118 around the color filter 116, the output step between the W pixels is suppressed.

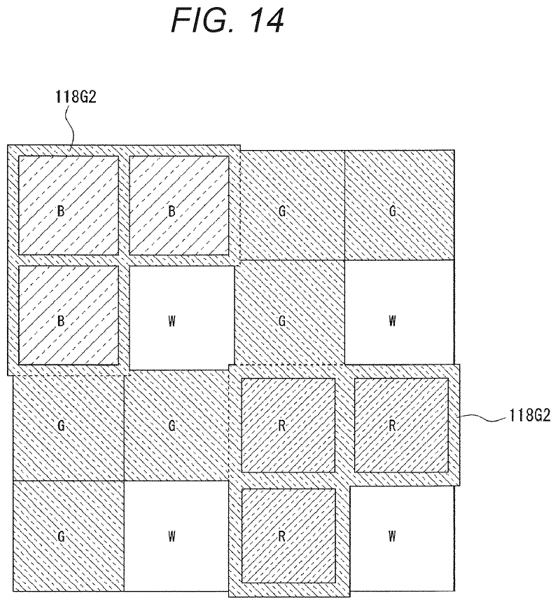

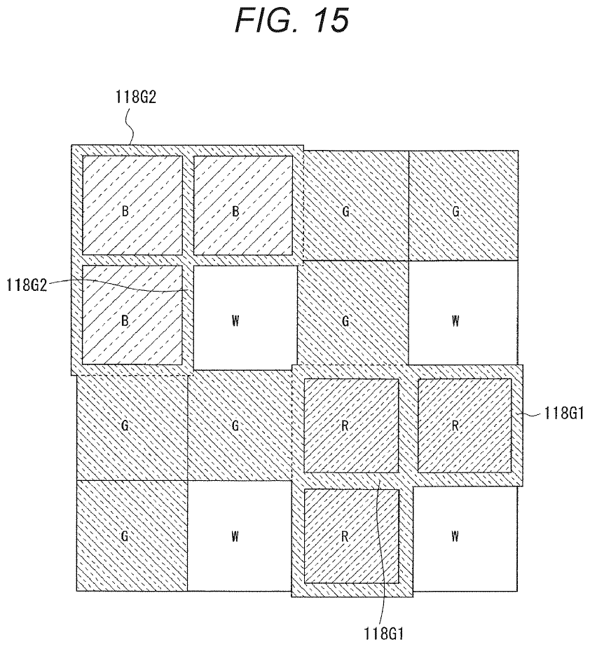

FIG. 14 is a partial plan view for explaining an example of a color arrangement configuration of outer peripheral color filters in the RGBW pixel array in the photodetection device 1 according to the embodiment of the present technology. As illustrated in the drawing, in the RGBW pixel array, the outer peripheral color filters 118G1 and 118G2 are formed in the R pixel and the B pixel, respectively. Therefore, the arrangement cycle of the color filters around each W pixel is unified in green. Furthermore, similarly to the above embodiment, the width of the outer peripheral color filter 118G1 around the R pixel is formed so as to be wider than the width of the outer peripheral color filter 118G2 around the B pixel.

As a result, it is possible to suppress deterioration in sensitivity of the B pixel while further suppressing color mixture from the R pixel to the W pixel. Note that, in the present example, the outer peripheral color filter 118G1 is formed in all the three R pixels, but the formation of the outer peripheral color filter 118G1 may be omitted for the R pixel adjacent to the G pixel (that is, the upper left R pixel).

### Modifications

FIG. 15 is a partial plan view for explaining another example of a color arrangement configuration of outer peripheral color filters in the RGBW pixel array in the photodetection device 1 according to the embodiment of the present technology. As illustrated in the drawing, the color arrangement configuration of the outer peripheral color filter 118 of the present example is configured by forming the red outer peripheral color filter 118R around the B pixel. Therefore, the arrangement cycle of the color filters around the W pixels is unified in green×2 and red×2. As a result, the output step between the W pixels can be eliminated.

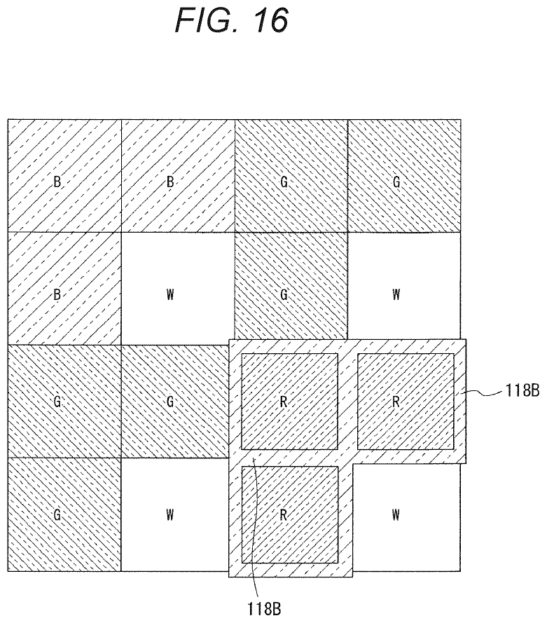

FIG. 16 is a partial plan view for explaining still another example of a color arrangement configuration of outer peripheral color filters in the RGBW pixel array in the photodetection device 1 according to the embodiment of the present technology. As illustrated in the drawing, in the outer peripheral color filter 118 of the present example, a blue outer peripheral color filter 118R is formed around the R pixel. Therefore, the arrangement cycle of the color filters around the W pixels is unified in green×2 and blue×2. As a result, the output step between the W pixels can be eliminated.

Note that, in the present embodiment, the width of the light shielding film 113 formed on the Si semiconductor layer 111 is constant, but the present invention is not limited thereto. As described in the second embodiment, the width of the light shielding film 113 may be appropriately set in accordance with the wavelength characteristics of each of the RGB color filters 116.

### 4. Example of Application to Mobile Object

The technology according to the present disclosure (the present technology) can be applied to various products. For example, the technology according to the present disclosure may be achieved in the form of a device to be mounted on a mobile object of any kind, such as an automobile, an electric vehicle, a hybrid electric vehicle, a motorcycle, a bicycle, a personal mobility, an airplane, a drone, a vessel, or a robot.

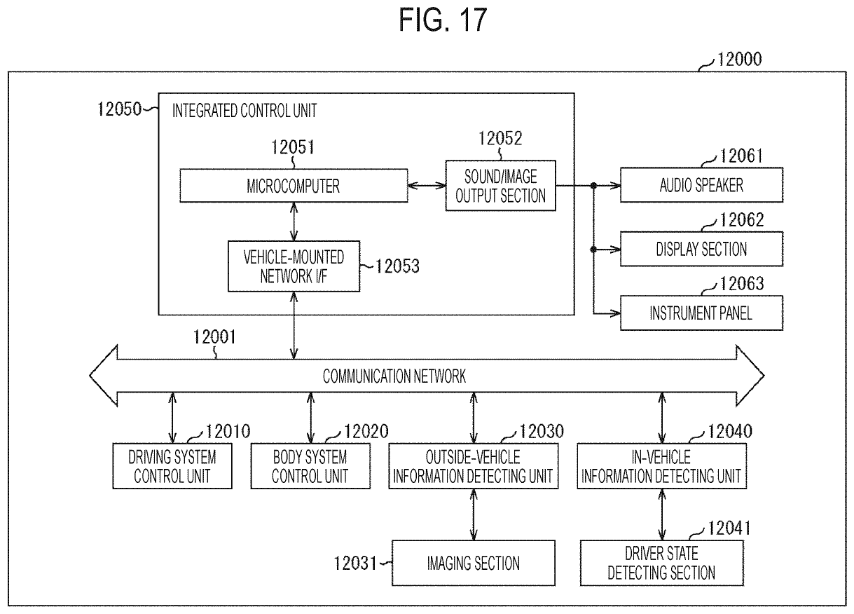

FIG. 17 is a block diagram illustrating a schematic configuration example of a vehicle control system as an example of a moving body control system to which the technology according to the present disclosure can be applied.

A vehicle control system 12000 includes a plurality of electronic control units connected to each other via a communication network 12001. In the example illustrated in FIG. 17, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle on which the vehicle control system 12000 is mounted. For example, the outside-vehicle information detecting unit 12030 is connected to an imaging section 12031. The outside-vehicle information detecting unit 12030 causes the imaging section 12031 to capture an image of the outside of the vehicle, and receives the captured image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light and outputs an electric signal corresponding to a received light amount of the light. The imaging section 12031 can output the electric signal as an image, or can output the electric signal as information about a measured distance.

Furthermore, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected to a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether or not the driver is dozing.

The microcomputer 12051 can calculate a control target value for the driving force generating device, the steering mechanism, or the braking device on the basis of the information about the inside or outside of the vehicle, the information being obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS), the functions including collision avoidance or shock mitigation for the vehicle, following driving based on a following distance, vehicle speed maintaining driving, a warning of collision of the vehicle, a warning of deviation of the vehicle from a lane, or the like.

Furthermore, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle, the information being obtained by the outside-vehicle information detecting unit 12030 or the in-vehicle information detecting unit 12040.

Furthermore, the microcomputer 12051 can output a control command to the body system control unit 12030 on the basis of the information about the outside of the vehicle, the information being obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or auditorily notifying information to an occupant of the vehicle or the outside of the vehicle. In the example in FIG. 17, as the output device, an audio speaker 12061, a display section 12062, and an instrument panel 12063 are illustrated. The display section 12062 may, for example, include at least one of an on-board display or a head-up display.

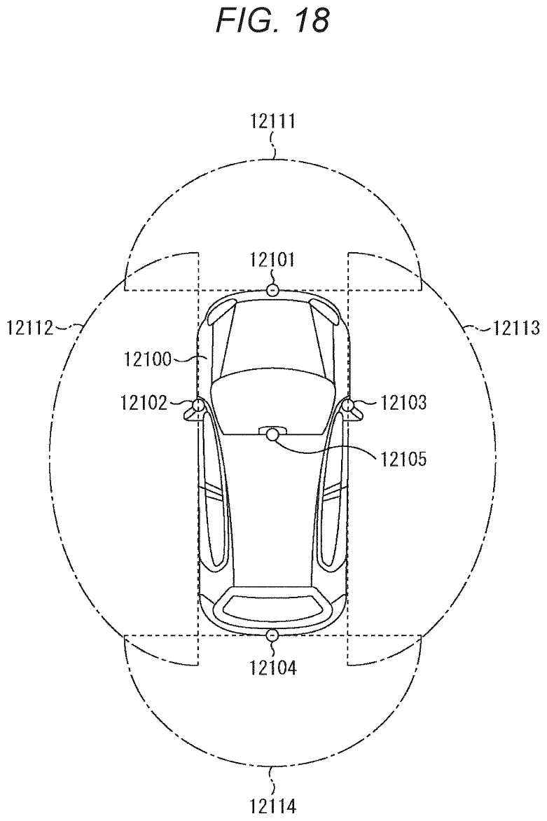

FIG. 18 is a diagram illustrating an example of the installation position of the imaging section 12031.

In FIG. 18, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 18 illustrates examples of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data captured by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 determines a distance to each three-dimensional object within the imaging ranges 12111 to 12114 and a temporal change in the distance (relative speed with respect to the vehicle 12100) on the basis of the distance information obtained from the imaging sections 12101 to 12104, and thereby can extract, as a preceding vehicle, a nearest three-dimensional object in particular that is present on a traveling path of the vehicle 12100 and travels in substantially the same direction as the vehicle 12100 at a predetermined speed (for example, equal to or more than 0 km/hour). Moreover, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is higher than or equal to a set value and there is thus a possibility of collision, the microcomputer 12051 can output a warning to the driver via the audio speaker 12061 or the display section 12062 and perform forced deceleration or avoidance steering via the driving system control unit 12010 to perform driving assistance for collision avoidance.

At least one of the imaging sections 12101 to 12104 may be an infrared camera that detects infrared rays. The microcomputer 12051 can, for example, recognize a pedestrian by determining whether or not there is a pedestrian in images captured by the imaging sections 12101 to 12104. Such recognition of a pedestrian is, for example, performed by a procedure of extracting characteristic points in the captured images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the captured images of the imaging sections 12101 to 12104, and thus recognizes the pedestrian, the sound/image output section 12052 controls the display section 12062 so that a square contour line for emphasis is displayed so as to be superimposed on the recognized pedestrian. Furthermore, the sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging section 12031 among the constituents described above.

Specifically, the photodetection device 1 illustrated in FIG. 1 can be applied to the imaging section 12031. By applying the technology according to the present disclosure to the imaging section 12031, the output step between the W pixels is suppressed, and it is possible to obtain a more accurate and easily viewable captured image, so that driver's fatigue can be reduced.

### 5. Summary

Each of the above-described embodiments is an example for describing the present technology, and is not intended to limit the present technology only to these embodiments. The present technology can be implemented in various forms without departing from the gist thereof.

For example, in the methods disclosed in the present specification, steps, operations, or functions may be performed in parallel or in a different order as long as there is no inconsistency in the results. The described steps, operations, and functions are provided merely as examples, and some of the steps, operations, and functions may be omitted without departing from the gist of the technology, or may be combined and integrated, or another step, operation, or function may be added.

In addition, although various embodiments are disclosed in the present specification, certain features (technical matters) in one embodiment can be added to or replaced with certain features in other embodiments while being modified as appropriate, and such forms are also included in the gist of the present invention.

Furthermore, the present technology may include the following technical matters.
(1)

A photodetection device including a pixel array section in which a plurality of pixels is arranged in an array,
in which each of the plurality of pixels includes:
a photoelectric conversion element capable of generating an electric signal corresponding to received light; and
a color filter that is formed according to a predetermined color filter pattern on a light receiving surface of the photoelectric conversion element and transmits light of a specific wavelength band among the light, the light receiving surface receiving the light, and
the plurality of pixels includes:
a first pixel including a first color filter that transmits light of a first wavelength band;
a second pixel adjacent to the first pixel and including a second color filter that transmits light of a second wavelength band;
a third pixel adjacent to the first pixel and including a third color filter that transmits light of a third wavelength band having a peak wavelength shorter than a peak wavelength of the second wavelength band; and
a fourth pixel adjacent to the first pixel and including a fourth color filter that transmits light of a fourth wavelength band having a peak wavelength shorter than a peak wavelength of the third wavelength band, and
the second pixel includes a first outer peripheral color filter that is formed so as to surround the second color filter and transmits light of the third wavelength band.
(2)

The photodetection device according to (1),
in which the fourth pixel includes a second outer peripheral color filter that is formed so as to surround the second color filter and transmits light of the third wavelength band.
(3)

The photodetection device according to (2),
in which a width of the first outer peripheral color filter is wider than a width of the second outer peripheral color filter in a plane parallel to the light receiving surface.
(4)

The photodetection device according to (2) or (3),
in which the first outer peripheral color filter is formed so as to avoid a portion where the corners of the second pixels intersect each other, and
the second outer peripheral color filter is formed so as to avoid a portion where the corners of the fourth pixel intersect each other.
(5)

The photodetection device according to any one of (1) to (3),
in which each of the plurality of pixels includes a light shielding film that is formed between a light receiving surface of the photoelectric conversion element and the color filter and defines a light receiving region of the photoelectric conversion element.
(6)

The photodetection device according to (5),
in which a width of the light shielding film is defined according to the specific wavelength of the light transmitted by the color filter formed in the pixel.
(7)

The photodetection device according to (6),
in which the light receiving region defined by the light shielding film of the second pixel is wider than the light receiving region defined by the light shielding film of the fourth pixel.
(8)

A photodetection device including a pixel array section in which a plurality of pixels is arranged in an array,
in which each of the plurality of pixels includes:
a photoelectric conversion element capable of generating an electric signal corresponding to received light; and
a color filter that is formed according to a predetermined color filter pattern on a light receiving surface of the photoelectric conversion element and transmits light of a specific wavelength band among the light, the light receiving surface receiving the light, and
the plurality of pixels includes:
a first pixel including a first color filter that transmits light of a first wavelength band;
a second pixel adjacent to the first pixel and including a second color filter that transmits light of a second wavelength band;
a third pixel adjacent to the first pixel and including a third color filter that transmits light of a third wavelength band having a peak wavelength shorter than a peak wavelength of the second wavelength band; and
a fourth pixel adjacent to the first pixel and including a fourth color filter that transmits light of a fourth wavelength band having a peak wavelength shorter than a peak wavelength of the third wavelength band, and
the fourth pixel includes a third outer peripheral color filter that is formed so as to surround the second color filter and transmits light of the second wavelength band.
(9)

A photodetection device including a pixel array section in which a plurality of pixels is arranged in an array,
in which each of the plurality of pixels includes:
a photoelectric conversion element capable of generating an electric signal corresponding to received light; and
a color filter that is formed according to a predetermined color filter pattern on a light receiving surface of the photoelectric conversion element and transmits light of a specific wavelength band among the light, the light receiving surface receiving the light, and
the plurality of pixels includes:
a first pixel including a first color filter that transmits light of a first wavelength band;
a second pixel adjacent to the first pixel and including a second color filter that transmits light of a second wavelength band;
a third pixel adjacent to the first pixel and including a third color filter that transmits light of a third wavelength band having a peak wavelength shorter than a peak wavelength of the second wavelength band; and
a fourth pixel adjacent to the first pixel and including a fourth color filter that transmits light of a fourth wavelength band having a peak wavelength shorter than a peak wavelength of the third wavelength band, and
the second pixel includes a fourth outer peripheral color filter that is formed so as to surround the second color filter and transmits light of the second wavelength band.
(10)

The photodetection device according to any one of (1) to (9),
in which the array of the plurality of pixels includes an RGBW pixel array in which the first pixels are arrayed on the basis of a Bayer array.
(11)

The photodetection device according to any one of (1) to (9),
in which the array of the plurality of pixels includes an RGBW pixel array in which the first pixels are arrayed on the basis of a quad Bayer array.

### REFERENCE SIGNS LIST

1 photodetection device
11 First semiconductor substrate
111 Si semiconductor layer
1111 Semiconductor region
1112 Silicon-oxide film
112 Wiring layer
113 Light shielding film
114 Pixel separation portion
115 Planarization film
116 Color filter
117 On-chip lens
118 Outer peripheral color filter
12 Second semiconductor substrate 12
121 Si semiconductor layer
122 Wiring layer
13 Pixel array section
P Pixel

What is claimed is:

1. A photodetection device comprising a pixel array section in which a plurality of pixels is arranged in an array,
wherein each of the plurality of pixels includes:
a photoelectric conversion element capable of generating an electric signal corresponding to received light; and
a color filter that is formed according to a predetermined color filter pattern on a light receiving surface of the photoelectric conversion element and transmits light of a specific wavelength band among the light, the light receiving surface receiving the light, and
the plurality of pixels includes:
a first pixel including a first color filter that transmits light of a first wavelength band;
a second pixel adjacent to the first pixel and including a second color filter that transmits light of a second wavelength band;
a third pixel adjacent to the first pixel and including a third color filter that transmits light of a third wavelength band having a peak wavelength shorter than a peak wavelength of the second wavelength band; and
a fourth pixel adjacent to the first pixel and including a fourth color filter that transmits light of a fourth wavelength band having a peak wavelength shorter than a peak wavelength of the third wavelength band, and
the second pixel includes a first outer peripheral color filter that is formed so as to surround the second color filter and transmits light of the third wavelength band.

2. The photodetection device according to claim 1,
wherein the fourth pixel includes a second outer peripheral color filter that is formed so as to surround the second color filter and transmits light of the third wavelength band.

3. The photodetection device according to claim 2,
wherein a width of the first outer peripheral color filter is wider than a width of the second outer peripheral color filter in a plane parallel to the light receiving surface.

4. The photodetection device according to claim 2,
wherein the first outer peripheral color filter is formed so as to avoid a portion where corners of the second pixels intersect each other, and
the second outer peripheral color filter is formed so as to avoid a portion where corners of the fourth pixel intersect each other.

5. The photodetection device according to claim 3,
wherein each of the plurality of pixels includes a light shielding film that is formed between a light receiving surface of the photoelectric conversion element and the color filter and defines a light receiving region of the photoelectric conversion element.

6. The photodetection device according to claim 5,
wherein a width of the light shielding film is defined according to the specific wavelength of the light transmitted by the color filter formed in the pixel.

7. The photodetection device according to claim 6,
wherein the light receiving region defined by the light shielding film of the second pixel is wider than the light receiving region defined by the light shielding film of the fourth pixel.

8. A photodetection device comprising a pixel array section in which a plurality of pixels is arranged in an array,
wherein each of the plurality of pixels includes:
a photoelectric conversion element capable of generating an electric signal corresponding to received light; and
a color filter that is formed according to a predetermined color filter pattern on a light receiving surface of the photoelectric conversion element and transmits light of a specific wavelength band among the light, the light receiving surface receiving the light, and
the plurality of pixels includes:
a first pixel including a first color filter that transmits light of a first wavelength band;
a second pixel adjacent to the first pixel and including a second color filter that transmits light of a second wavelength band;
a third pixel adjacent to the first pixel and including a third color filter that transmits light of a third wavelength band having a peak wavelength shorter than a peak wavelength of the second wavelength band; and
a fourth pixel adjacent to the first pixel and including a fourth color filter that transmits light of a fourth wavelength band having a peak wavelength shorter than a peak wavelength of the third wavelength band, and
the fourth pixel includes a third outer peripheral color filter that is formed so as to surround the second color filter and transmits light of the second wavelength band.

9. A photodetection device comprising a pixel array section in which a plurality of pixels is arranged in an array,
wherein each of the plurality of pixels includes:
a photoelectric conversion element capable of generating an electric signal corresponding to received light; and
a color filter that is formed according to a predetermined color filter pattern on a light receiving surface of the photoelectric conversion element and transmits light of a specific wavelength band among the light, the light receiving surface receiving the light, and
the plurality of pixels includes:
a first pixel including a first color filter that transmits light of a first wavelength band;
a second pixel adjacent to the first pixel and including a second color filter that transmits light of a second wavelength band;
a third pixel adjacent to the first pixel and including a third color filter that transmits light of a third wavelength band having a peak wavelength shorter than a peak wavelength of the second wavelength band; and
a fourth pixel adjacent to the first pixel and including a fourth color filter that transmits light of a fourth wavelength band having a peak wavelength shorter than a peak wavelength of the third wavelength band, and
the second pixel includes a fourth outer peripheral color filter that is formed so as to surround the second color filter and transmits light of the second wavelength band.

10. The photodetection device according to claim 1,
wherein the array of the plurality of pixels includes an RGBW pixel array in which the first pixels are arrayed on a basis of a Bayer array.

11. The photodetection device according to claim 1,
wherein the array of the plurality of pixels includes an RGBW pixel array in which the first pixels are arrayed on a basis of a quad Bayer array.
